(19) United States
(12) Patent Application Publication
(10) Pub. No.: US 2024/0291993 A1
(43) Pub. Date: Aug. 29, 2024

(54) RULE-BASED DIGITIZED IMAGE COMPRESSION

(71) Applicant: Ford Global Technologies, LLC, Dearborn, MI (US)

(72) Inventors: Jonathan Diedrich, Carleton, MI (US); Medha Karkare, Canton, MI (US)

(73) Assignee: Ford Global Technologies, LLC, Dearborn, MI (US)

(21) Appl. No.: 18/175,631

(22) Filed: Feb. 28, 2023

(51) Int. Cl. H04N 19/137; G06T 7/11; G06T 7/20; H04N 19/167

(52) U.S. Cl. CPC H04N 19/137; G06T 7/11; G06T 7/20; H04N 19/167; G06T 2207/30181; G06T 2207/30196; G06T 2207/30236; G06T 2207/30252

(57) ABSTRACT

In a vehicle, an onboard vehicle camera may identify, based on non-camera sensor data, a first portion of an image obtained by the camera that includes an area of interest. A first compression rule may be applied to portions of the image that include the area of interest. A second compression rule may be applied to portions of the image that exclude the area of interest.

### BACKGROUND

Vehicles may utilize an onboard camera to provide digitized images of an environment external to the vehicle for display to a driver and/or for processing by various vehicle systems. In some instances, such as may be encountered in relatively static, featureless driving environments, digitized images transmitted from a vehicle camera may be easily accommodated by the vehicle's onboard communications network. However, in other instances, such as may be encountered when driving in relatively dynamic environments, such as through crowded urban environments or along roadways populated with numerous stationary and/or moving vehicles, output data transmitted from a vehicle camera may place much greater demands on the vehicle's onboard communications network.

### BRIEF DESCRIPTION OF THE DRAWINGS

FIG. 1 is a block diagram of an example vehicle system for rule-based digitized image compression.

FIGS. 2A, 2B, and 3 are diagrams depicting an example traffic scene.

FIG. 4 is a diagram depicting a second example traffic scene.

FIG. 5 is a process flow diagram illustrating an example process for rule-based digitized image compression.

### DESCRIPTION

### Introduction

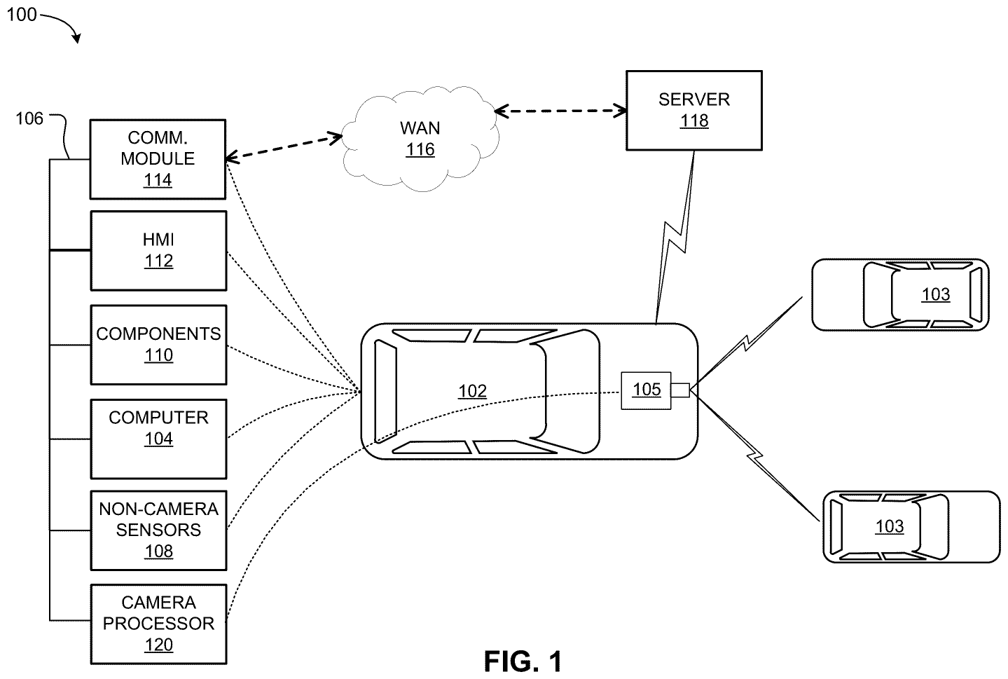

Referring to FIGS. 1-4, the present disclosure describes a system 100 in which rule-based digitized image compression can be provided in vehicle 102. In the context of this disclosure, rule-based digitized image compression refers to compression of images generated by a vehicle camera responsive to obtaining input signals from non-camera sensing devices. Accordingly, as vehicle 102 operates on a roadway, an onboard camera operates such that image parameters and/or data at particular areas of interest of a scene are compressed according to one or more compression rules. Thus, in an example, a first compression rule may indicate that decreased (e.g., zero or negligible) compression is to be applied to portions of a scene corresponding to an area of interest. In an example, a portion of a digitized image that represents an area of interest, which may include an area comprising objects, such as other vehicles, pedestrians, animals, stationary objects, and/or moving objects may undergo zero or negligible, e.g., lossless, compression in accordance with the first compression rule. Portions of a scene outside of an area of interest may undergo compression, e.g., lossy compression, in accordance with the second compression rule. By utilizing such first and second compression rules, onboard communications network loading may be reduced while continuing to provide uncompressed and potentially higher resolution images for use by a vehicle computer, which may perform various motion prediction analyses, object recognition, driver assistance, and so forth.

A system for rule-based digitized image compression comprises a processor coupled to a memory that stores instructions executable by the processor to: obtain a camera image to include a scene; identify, from non-camera sensor data, an area of interest in the scene; identify, based on the non-camera sensor data, a first portion of the camera image that includes the area of interest and a second portion of the camera image that excludes the area of interest; and to apply a first compression rule to the first portion of the camera image and a second compression rule to the second portion of the camera image, wherein the first compression rule is less lossy than the second compression rule.

A first compression rule may operate to decrease compression of the first portion of the camera image and/or to decrease compression nearby the first portion of the camera image.

A first compression rule may operate to determine whether the first portion of the camera image includes a moving object or includes a stationary object.

A first compression rule may operate to apply a first level of decreased compression responsive to a determination that the first portion of the camera image indicates presence of a moving object.

A first compression rule may operate to apply a second level of decreased compression responsive to a determination that the first portion of the camera image indicates presence of a stationary object.

A first compression rule may operate to apply zero or negligible compression responsive to a determination that the area of interest indicates presence of a moving object wherein the moving object may include a moving vehicle, a moving pedestrian, a moving bicyclist, a moving motorcycle, a moving natural object, a moving animal, and so forth.

A first compression rule may apply non-zero or non-negligible compression responsive to a determination that the area of interest includes a stationary vehicle, a stationary pedestrian, a stationary bicyclist, a stationary natural object, a stationary animal, and so forth.

A non-camera sensor may include at least one of a LIDAR sensor, a radar sensor, an infrared sensor, and an ultrasonic sensor.

A second compression rule may operate to apply lossy compression in the second portion of the camera image that includes free space.

A method of rule-based digitized image compression comprises: obtaining a camera image that includes a scene; identifying, from non-camera sensor data, and area of interest in the scene; identifying, based on the non-camera sensor data, a first portion of the camera image that includes the area of interest and a second portion of the camera image that excludes the area of interest; applying a first compression rule to the first portion of the camera image and a second compression rule to the second portion of the camera image, wherein the first compression rule is less lossy than the second compression rule.

Applying the first compression rule may include zero or negligible compression of the first portion of the camera image.

Applying the first compression rule may bring about zero or negligible compression of an area nearby the first portion of the camera image.

A method may additionally include determining whether an object included in the first portion of the camera image corresponds to a moving object or corresponds to a stationary object.

A method may additionally include applying the first compression rule to include zero or negligible compression to the first portion of the camera image based on the first portion of the camera image including a moving object and applying non-zero or non-negligible compression based on the first portion of the camera image based on the first portion of the camera image including a stationary object.

An article, which may comprise a non-transitory computer-readable media having instructions coded thereon which, when executed by a processor coupled to at least one memory may be operable to: obtain a camera image to include a scene; identify, from non-camera sensor data, and area of interest in a scene; identify, based on the non-camera sensor data, a first portion of the camera image that includes the area of interest and a second portion of the camera image that excludes the area of interest; and to apply a first compression rule to the first portion of the camera image and a compression rule to the second portion of the camera image, wherein the first compression rule is less lossy than the second compression rule.

Instructions encoded on the article may additionally determine whether the first portion of the camera image includes a moving object or includes a stationary object.

Instructions encoded on the article may operate to apply zero or negligible compression to the first portion of the camera image responsive to determining that the first portion of the camera image includes a moving object.

Instructions encoded on the article may operate to apply non-zero or non-negligible compression to the first portion of the camera image responsive to determining that the first portion of the camera image includes a stationary object.

### System Elements

As seen in FIG. 1, system 100 includes vehicle 102, which, in turn, includes a computer 104 that is communicatively coupled via a communication network, such as vehicle network 106, with various elements including non-camera sensors 108, subsystems or components 110 such as steering, propulsion, and braking, human machine interface (HMI) 112, and communication module 114.

Vehicle computer 104 (and also remote server 118 discussed below) includes a processor and a memory. A memory of computer 104, such as those described herein, includes one or more forms of non-transitory media readable by computer 104, and may store instructions executable by vehicle computer 104 for performing various operations, such that the vehicle computer is configured to perform the various operations, including those disclosed herein.

For example, vehicle computer 104 may comprise a generic computer with a processor and memory as described above and/or may include an electronic control unit ECU or controller for a specific function or set of functions, and/or a dedicated electronic circuit including an ASIC (application specific integrated circuit) that is manufactured for a particular operation, (e.g., an ASIC for processing data from non-camera sensors and/or communicating data from non-camera sensors 108.) In another example, vehicle computer 104 may include an FPGA (Field-Programmable Gate Array), which is an integrated circuit manufactured to be configurable by a user. In example embodiments, a hardware description language such as VHDL (Very High Speed Integrated Circuit Hardware Description Language) may be used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected or coupled to the FPGA circuit.) In some examples, a combination of processor(s), ASIC(s), and/or FPGA circuits may be included in computer 104. Further, vehicle computer 104 may include a plurality of computers 104 in the vehicle (e.g., a plurality of ECUs (electronic control units) or the like) operating together to perform operations ascribed herein to the vehicle computer 104.

The memory can be of any type, such as hard disk drives, solid state drives, servers 118, or any volatile or non-volatile media. The memory can store the collected data sent from non-camera sensors 108. The memory can be a separate device from computer 104, and computer 104 can retrieve information stored by the memory via a communication network in the vehicle such as the vehicle network 106, e.g., over a CAN bus, a wireless network. Alternatively or additionally, the memory can be part of computer 104, for example, as a memory internal to computer 104.

Computer 104 may include or access program instructions to operate one or more components 110 such as vehicle brakes, propulsion (e.g., one or more of an internal combustion engine, electric motor, hybrid engine, etc.), steering, climate control, interior and/or exterior lights, etc., as well as to determine whether and when computer 104, as opposed to a human operator, is to control such operations. Additionally, computer 104 may be programmed to determine whether and when a human operator is to control such operations. Computer 104 may include or be communicatively coupled to, e.g., via vehicle network 106 such as a communications bus as described further below, more than one processor, e.g., included in components 110 such as non-camera sensors 108, electronic control units (ECUs) or the like included in the vehicle for monitoring and/or controlling various vehicle components, e.g., a powertrain controller, a brake controller, a steering controller, etc.

Computer 104 may be generally arranged for communications on vehicle network 106 that can include a communications bus in the vehicle such as a controller area network CAN or the like, and/or other wired and/or wireless mechanisms. Vehicle network 106 corresponds to a communications network, which may facilitate exchange of messages between various onboard vehicle devices, e.g., non-camera sensors 108, components 110, computer(s) 104. Computer 104 can be generally programmed to send and/or receive, via vehicle network 106, messages to and/or from other devices in vehicle, e.g., any or all of ECUs, non-camera sensors 108, actuators, components 110, communications module, human machine interface (HMI) 112. For example, various component 110 subsystems (e.g., components 110 can be controlled by respective ECUs). Non-camera sensors 108 may provide data to the computer 104 via the vehicle network 106.

Further, in embodiments in which computer 104 actually comprises a plurality of devices, vehicle network 106 may be used for communications between devices represented as computer 104 in this disclosure. For example, vehicle network 106 can include a controller area network (CAN) in which messages are conveyed via a CAN bus, or a local interconnect network (LIN) in which messages are conveyed via a LIN bus. In some implementations, vehicle network 106 can include a network in which messages are conveyed using other wired communication technologies and/or wireless communication technologies, e.g., Ethernet, Wi-Fi®, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices onboard a vehicle. For example, vehicle network 106 can include a CAN (or CAN bus) in which some devices in-vehicle communicate via a CAN bus, and a wired or wireless local area network in which some device in vehicle communicate according to Ethernet or Wi-Fi® communication protocols.

Vehicle 102 typically includes a variety of non-camera sensors 108. Non-camera sensors 108 may correspond to a suite of devices that can obtain one or more measurements of one or more physical phenomena. Some non-camera sensors 108 detect internal states of the vehicle, for example, wheel speed, wheel orientation, and engine and transmission variables. In example embodiments, non-camera sensors 108 may operate to detect the position or orientation of the vehicle, for example, global positioning system GPS sensors; accelerometers, such as piezo-electric or microelectromechanical systems MEMS; gyroscopes such as rate, ring laser, or fiber-optic gyroscopes; inertial measurement units IMU; and magnetometers. In example embodiments, non-camera sensors 108 may operate to detect aspects of the environment external to vehicle 102, such as radar sensors, scanning laser range finders, light detection and ranging (LIDAR) devices. Vehicle 102 may additionally include camera 105, or other type of imaging device, which may operate to digitize a scene corresponding to an area in an environment external to vehicle 102, such as a scene that includes other vehicles 103. A LIDAR device detects distances to objects by emitting laser pulses and measuring the time of flight for the pulse to travel to the object and back. Some non-camera sensors 108 may comprise communications devices, for example, vehicle-to-infrastructure V2I or vehicle-to-vehicle V2V devices. Camera 105 and non-camera sensors 108 may be impacted by obstructions, such as dust, snow, insects, etc. Often, but not necessarily, camera processor 120 and non-camera sensors 108 may include a digital-to-analog converter to convert sensed analog data to a digital signal that can be provided to computer 104, e.g., via vehicle network 106.

Non-camera sensors 108 can include, or may communicate with, a variety of devices, and can be disposed to sense and environment, to provide data about a machine, etc., in a variety of ways. For example, components of non-camera sensors 108 may be mounted to a stationary infrastructure element on, over, or near a road. Moreover, various controllers in vehicle 102 may operate as non-camera sensors 108 to provide data via vehicle network 106 or bus, e.g., data relating to vehicle speed, acceleration, location, subsystem and/or component 110 status, etc. Further, other non-camera sensors 108, in or mounted on vehicle 102, stationary infrastructure element, etc., short range radar, long range radar, LIDAR, and/or ultrasonic transducers, weight sensors, accelerometers, motion detectors, etc. To provide just a few non-limiting examples, non-camera sensors 108 data could include data for determining a location of a component 110, a location of an object, a speed of an object, a type of an object, a slope of path 202, a temperature, a presence or amount of moisture, a fuel level, a data rate, etc.

Computer 104 may include programming to command one or more actuators to operate one or more vehicle subsystems or components 110, such as vehicle brakes, propulsion, or steering. That is, computer 104 may actuate control of a motion vector of vehicle 102, such as via control of one or more of an internal combustion engine, electric motor, hybrid engine, etc., and/or may actuate control of brakes, steering, climate control, interior and/or exterior lights, etc. Computer 104 may include or be communicatively coupled to, e.g., via vehicle network 106, more than one processor, e.g., included in components 110 such as non-camera sensors 108, electronic control units (ECUs), or the like, for monitoring and/or controlling various vehicle components, e.g., ECUs or the like such as a powertrain controller, a brake controller, a steering controller, etc.

Vehicle 102 can include HMI 112 (human-machine interface), e.g., one or more of a display, a touchscreen display, a microphone, a speaker, etc. A user, such as the driver of vehicle 102, can provide input to devices such as computer 104 via HMI 112. HMI 112 can communicate with computer 104 via vehicle network 106, e.g., HMI 112 can send a message including the user input provided via a touchscreen, microphone, a camera that captures a gesture, etc., to computer 104, and/or can display output, e.g., via a screen, speaker, etc. Further, operations of HMI 112 could be performed by a portable user device (not shown) such as a smart phone or the like in communication with vehicle computer 104, e.g., via Bluetooth or the like.

Computer 104 may be configured for communicating via vehicle-to-vehicle communication module 114 and/or may interface with devices outside of the vehicle, e.g., through wide area network 116 and/or vehicle to vehicle V2V, vehicle-to-infrastructure or everything V2X or vehicle-to-everything including cellular communications C-V2X wireless communications cellular, DSRC, etc., to another vehicle, to an infrastructure element typically via direct radio frequency communications and/or typically via network remote server 118. The module could include one or more mechanisms by which computers 104 of vehicles may communicate, including any desired combination of wireless, e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, dedicated short range communications DSRC, cellular V2X CV2X, and the like.

A computer 104 can be programmed to communicate with one or more remote sites such as remote server 118, via wide area network 116. Wide area network 116 can include one or more mechanisms by which a vehicle computer 104 may communicate with, for example, remote server 118. Server 118 may include one or more computing devices, e.g., having respective processors and memories and/or associated data stores, which may be accessible via wide area network 116. In example embodiments, vehicle 102 could include a wireless transceiver (i.e., transmitter and/or receiver) to send and receive messages outside of vehicle 102. Accordingly, the network can include one or more of various wired or wireless communication mechanisms, including any desired combination of wired e.g., cable and fiber and/or wireless, e.g., cellular, wireless, satellite, microwave, and radio frequency communication mechanisms and any desired network topology or topologies when multiple communication mechanisms are utilized. Exemplary communication networks include wireless communication networks, e.g., using Bluetooth, Bluetooth Low Energy BLE, IEEE 802.11, vehicle-to-vehicle V2V or vehicle to everything V2X such as cellular V2X CV2X, Dedicated Short Range Communications DSRC, etc., local area networks and/or wide area networks 116, including the Internet, providing data communication services.

Camera 105 may provide digitized images representing a scene of a portion of the environment external to vehicle 102. Although FIG. 1 depicts a single camera 105 to provide digitized images of an area in a direction forward of vehicle 102, vehicle 102 may (and typically does) include multiple cameras, so as to provide digitized images representing areas to the left of vehicle 102, to the right of vehicle 102, to the rear of vehicle 102, for example. Camera 105 may transmit images of regions external to vehicle 102, which may be displayed via HMI 112. Alternatively, or in addition to, images of regions external to vehicle 102 may be utilized by computer 104, which may facilitate detection of an object that may be in the driving path of vehicle 102. Camera processor 120 may employ a compression algorithm or technique, in which, for example, featureless areas of the environment external to vehicle 102 may be compressed, so as to reduce loading of vehicle network 106. Compression of digitized image data from camera 105 may result in a loss of image quality (e.g., lossy compression). Accordingly, in example embodiments, as described further below, it may be advantageous to perform lossy compression at particular portions of a digitized image from camera 105 while performing decreased, minimal, or negligible compression at other portions of a digitized image. Various suitable compression techniques may be utilized. For example, the camera processor 120 could encode frames of video data from camera 105 according to advanced video coding (AVC), also known as H.264 or MPEG-4. H.264 is typically used for lossy compression, but may also support encoding of images with lossless regions or encoding of images that are entirely lossless.

### Exemplary System Operations

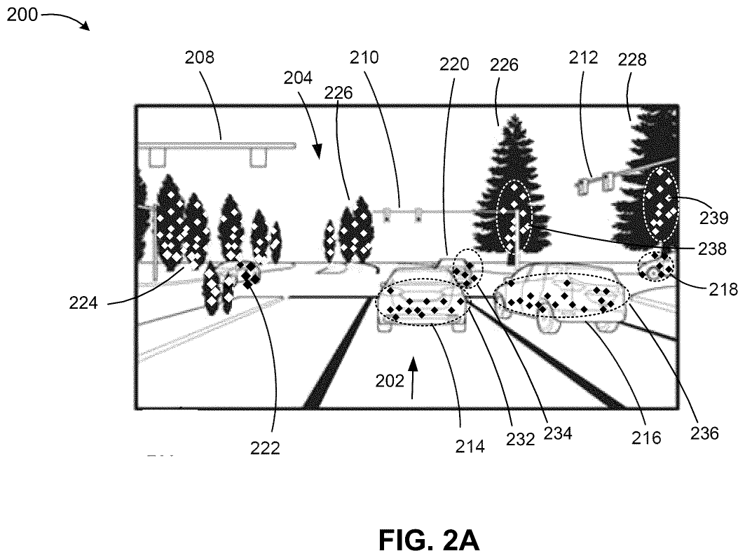

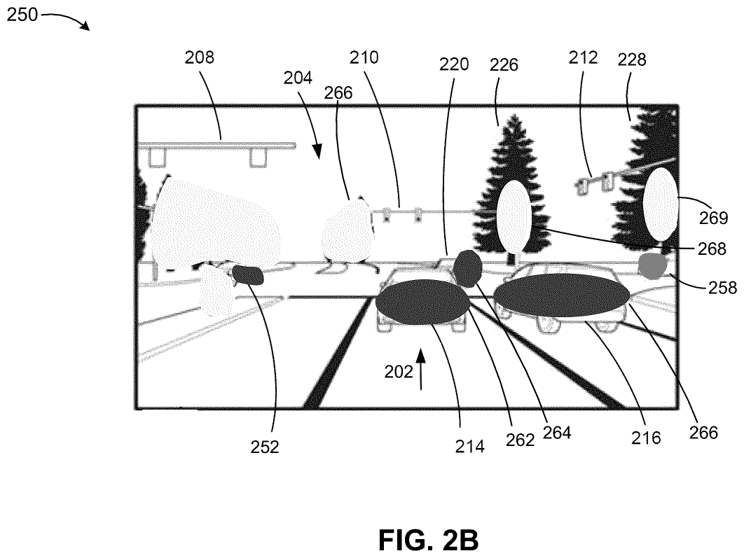

FIG. 2A shows view 200 of a scene captured via a camera as vehicle 102 proceeds along path 202. The scene of FIG. 2A also depicts rear portions of vehicle 214 and vehicle 220, which are presently located in a direction forward of vehicle 102, as vehicles 214 and 220 proceed along a path similar to path 202 of vehicle 102. FIG. 2A additionally depicts side and rear portions of vehicle 216, which is proceeding along a path parallel to path 202. FIG. 2A further depicts vehicles 218 and 222, which are currently located to the right and to the left (respectively) of path 202. The scene of FIG. 2A additionally depicts trees, such as trees 224, 226, and 228, as well as vertical and horizontal structures from which traffic lights, e.g., traffic lights 208, 210, and 212, are attached. View 200 may correspond to an image captured by an onboard camera of vehicle 102, e.g., camera 105 shown in FIG. 1.

Point groups 232, 234, and 236 can correspond to discrete measurement results provided by one or more of non-camera sensors 108 of FIG. 1, in which each point of a point group corresponds to a discrete range and/or velocity measurement performed by a non-camera sensor. In example embodiments, point groups 232, 234, and 236 can be formed by utilizing an onboard object-recognition computer-implemented process executing on computer 104. For example, responsive to a threshold number of measurements performed by non-camera sensors 108, in which each measurement indicates detection at pixel coordinates of objects moving at a similar velocity vector, computer 104 can classify point groups 232, 234, and 236 as representing a single a moving vehicle. In another example, responsive to a threshold number of measurements performed by non-camera sensors 108, in which each measurement indicates detection of an object having a negligible (or zero) velocity vector, computer 104 may classify other point groups, e.g., point groups 238 and 239, as corresponding to pixel coordinates that represent stationary objects. In a further example, non-camera sensors 108 may determine that pixel coordinates within scene 204 correspond to a free space portion of a scene, i.e., a portion of a scene in which neither stationary nor moving objects are detected.

To facilitate object detection, computer 104 can implement one or more object-classification processes, in which the computer operates to classify an object as a moving object, a stationary object, or free space based on a comparison between a set of non-camera measurements and various computer models of moving objects, stationary objects, and free space. Non-camera sensors 108 may utilize a common coordinate system e.g., polar or cartesian applied to an portion of the scene of FIG. 2A to specify locations and/or subareas according to the coordinate system, translated to global latitude and longitude geo-coordinates, etc. Computer 104 can employ any suitable technique(s) for fusing sensor data, which may include incorporating into a common coordinate system or frame of reference data from different sensors and/or types of sensors, e.g., ultrasonic, radar, and/or LIDAR.

Accordingly, point groups 232, 234, and 236 can each represent measurements from non-camera sensor 108, e.g. a radar sensor, an ultrasonic sensor, etc., which may operate to indicate that an object, e.g., vehicle 214, is currently located at a particular distance and in a forward direction with respect to vehicle 102. Similarly, point groups 234 and 236 can correspond to discrete measurement results of the locations and/or velocities of other objects, e.g., vehicles 220 and vehicles 216, are also located in substantially forward directions with respect to vehicle 102. Successive measurements may be performed by non-camera sensors 108 to provide estimations of the motion vectors of vehicles 216 and 220. These additional measurements may include ultrasonic measurements, radar measurements, measurements derived from satellites of a satellite positioning system, e.g., GPS, and so forth. For purposes of maintaining the clarity of FIG. 2A, point groups corresponding to discrete measurement results of the locations and/or velocities of vehicles 218 and 222 are not depicted in FIG. 2A.

FIG. 2B shows a view 250 of the scene of FIG. 2A depicting areas of a heat map in place of the point groups of FIG. 2A. Thus, in FIG. 2B, heat map area 262 is shown in place of point group 232, heat map area 262 is shown in place of point group 234, and heat map area 258 is shown in place of a point group representing vehicle 218 (of FIG. 2A.) Similarly, heat map area 252 is shown in place of a point group representing vehicle 222. FIG. 2B additionally depicts heat map areas 269 in place of point group 239 and heat map area 268 in place of point group 238. FIG. 2B shows additional heat map areas corresponding to trees viewable in the scene of FIG. 2A.

In example embodiments, such as that of FIG. 2B, objects indicated as moving vehicles are depicted utilizing a color scheme that contrasts with objects indicated as stationary. Selection of a color scheme to indicate moving objects via color scheme that contrasts moving objects from stationary objects, such as trees 224, 226, and 228, may indicate emphasis on moving objects in relation to stationary objects present in the scene of FIG. 2B. Heat map areas corresponding to objects indicated as moving vehicles may employ a color scheme that identifies moving objects as potentially posing a higher risk to vehicle 102 in relation to stationary objects and free space.

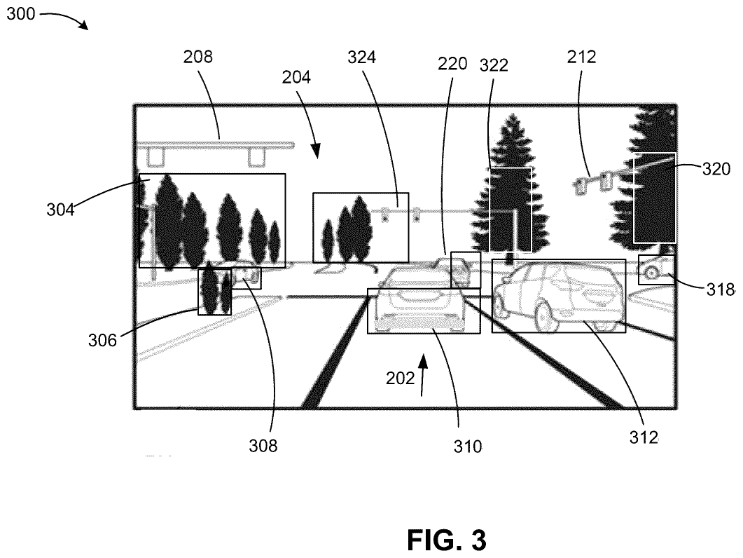

FIG. 3 shows a view of scene 300 captured via a camera as vehicle 102 proceeds along path 202. As depicted in FIG. 3, portions of the scene are depicted to identify various areas of interest surrounding or encompassing the various point groups depicted in FIG. 2A. An area of interest may be determined, e.g., utilizing an object detection/object classification process operating on computer 104 as described in reference to FIG. 2A. In example embodiments, computer 104 may operate to form an area of interest, which may encompass heat map areas depicted in FIG. 2B. In example embodiments, pixel coordinates of heat map areas determined via non-camera sensors 108 cooperating with computer 104 may be overlaid on scene 204 utilizing a coordinate system that is common to non-camera sensors 108 and camera 105. Accordingly, area of interest 306 can correspond to point group 232 described in reference to FIG. 2A. In addition, areas of interest 254 and 256 correspond to point groups 234 and 236, also described in reference to FIG. 2A. Additional areas of interest encompassing vehicles 218 and 222 are also depicted in FIG. 2A.

FIG. 3 also depicts portions of the scene represented by areas of interest determined according to point groups corresponding to stationary objects shown in FIG. 2. In example embodiments, computer 104 of FIG. 1 may be programmed to generate respective areas of interest 304, 306, 308, 310, 312, 318, 320, 322, and 324 around moving objects, such as other vehicles traveling parallel, or potentially intersecting, path 202 the areas of interest can be defined utilizing pixel coordinates of opposite corners of each of the areas of interest. For example, computer 104 may generate area of interest 310 around portions of scene 300 responsive to segmentation of a camera image identified by computer 104 as heat map area 262 of FIG. 2B. Computer 104 may generate each area of interest to be a minimum size encompassing a respective region, e.g., by using the highest and lowest vertical pixel coordinates and leftmost and rightmost horizontal pixel coordinates of the region to form pairs of pixel coordinates at the edges of each area of interest. Alternatively, computer 104 may generate some areas of interest as having dimensions larger than the minimum size encompassing a respective region, so as to include portions of scene 300 that are nearby to an area of interest. In example embodiments, generation of areas of interest having dimensions larger than a minimum size encompassing respective region, so as to encompass nearby portions of scene 300, may assist in ensuring that inter-frame movement of a moving object, for example, continues to coincide with an area of interest in a subsequent image frame.

Thus, referring to FIGS. 1-3, non-camera sensors 108 may operate to detect objects along a path, or objects that could potentially encroach a path, of vehicle 102. Non-camera sensors 108 and camera 105 may comprise overlapping fields-of-view. Individual measurements performed by non-camera sensors 108 may be collected to form point groups utilizing a coordinate system and platform that are common to both camera, e.g., camera 105, and non-camera sensors 108. In turn, point groups may be utilized to form areas of interest of a scene, such as depicted in FIG. 3.

An example embodiments, computer 104 of vehicle 102 may utilize a process to track areas of interest, such as area of interest 310, as vehicle 102 undergoes motion along path 202. For example, prediction of a path of vehicle 102 may utilize a path polynomial e.g., p(x) in a model that operates to protect the path of vehicle 102 within area of interest 310 as a line traced by a polynomial equation. A path polynomial (p(x)) may predict the path of the vehicle within area of interest 310 for a predetermined upcoming distance (x) determining a lateral coordinate p, e.g., measured in meters, as given by expression (1) below:

$$p ( x ) = {a}_{0} + {a}_{1} x + {a}_{2} {x}^{2} + {a}_{3} {x}^{3} \qquad ( 1 )$$

where a₀ represents an offset, e.g., a lateral distance between path 202 and a center line of vehicle 102 at an upcoming distance x. a₁ corresponds to a heading angle of the path, a₂ corresponds to a curvature of the path, and a₃ corresponds to a rate of curvature rate of the path. Responsive to generating a planned path P, vehicle computer 104 can provide the planned path and parameters with respect to the environment, including an object, such as a moving vehicle within scene 300, to vehicle computer 104.

In response to formation of portions of the scene corresponding to areas of interest, camera 105 can apply a first compression rule which may indicate that zero or negligible compression is to be applied to portions of a scene corresponding to an area of interest. A second compression rule may indicate that compression is to be applied to portions of the scene outside of areas of interest, such as areas corresponding to free space. In example embodiments, a compression rule may indicate that zero or negligible compression is to be applied to portions of the scene corresponding to areas of interest that include moving objects, while an intermediate level of compression, e.g., non-zero or non-negligible compression, is to be applied to portions of the scene corresponding to areas of interest that include stationary objects. In example embodiments, an amount of compression to be applied to a portion of an image may be determined by specifying a fidelity for the portion of the image, i.e., an amount of information that can be lost in the portion of the image representing the portion of the scene. A portion of a scene can be assigned a minimum required fidelity based on a type of object detected in the scene, e.g., a background or stationary object may have a lower required fidelity than a moving object. A minimum required fidelity can then be associated with an amount of compression. An amount of compression may be defined in accordance with a quantization parameter, such as specified in video compression standard H.26x or one of its related components. Different quantization parameters can thus be applied to different areas of interest within a scene, and hence to different portions of an image of the scene. Compression utilizing varying quantization parameters for different portions of an image can be performed based on a compression algorithm.

In example embodiments, video or static scene compression may introduce losses in scene data and/or resolution. However, such losses, e.g., at portions of a scene corresponding to free space, may be acceptable and may not result in loss of significant image data. In addition, compression of relatively unimportant portions of a scene may decrease vehicle communications network loading, thus ensuring that bandwidth of a vehicle network is available for other types of network traffic. Thus, via application of compression rules, in which relatively unimportant portions of a scene (e.g., free space) may be compressed while areas of interest remain uncompressed, ample vehicle network bandwidth may be available for conveying uncompressed image data from other portions of the scene, such as areas of interest 306, 308, 310, 312, and so forth.

As noted previously, non-camera sensors 108 of FIG. 1 may be capable of determining whether an object within a scene corresponds to a stationary object or to a moving object. Hence, in example embodiments, responsive to detection of a moving object in a scene, a compression rule may indicate that an area of interest corresponding to a portion of a scene including the moving object may be extended to include a nearby portion of the scene. In accordance with a compression rule, including portions of a scene nearby to a moving object may ensure that inter-frame movement of the moving object continues to be located in an area of interest. Further, responsive to determining that a moving object comprises a velocity vector that is relatively high with respect to vehicle 102, a compression rule may indicate that portions of the scene nearby the moving object may be extended so as to ensure that the moving object remains within an area of interest between static or video image capture events. In example embodiments, portions of the scene nearby the moving object may be categorized as a buffer zone, which may be based on a configurable pixel parameter selected based on a buffer zone determined by empirical testing and/or simulation of capturing relevant object data. Compression can then be applied on a pixel basis, for example, to pixels within the buffer zone.

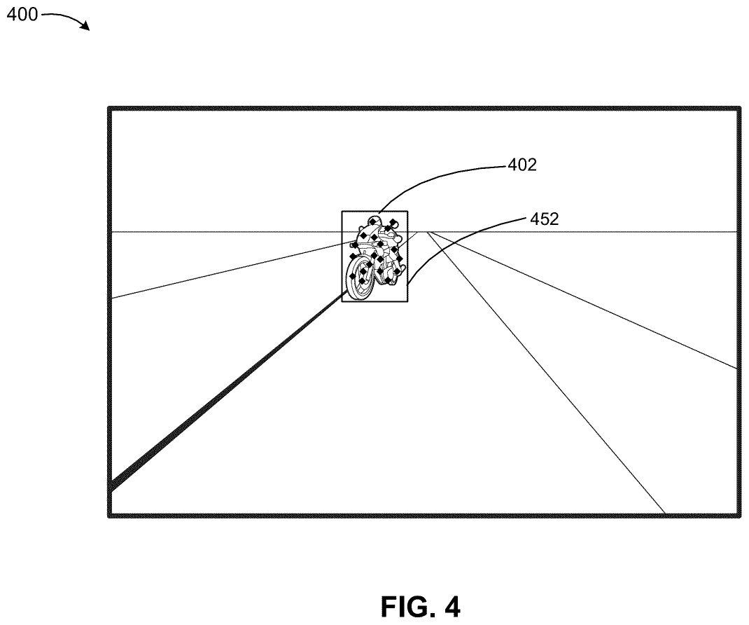

FIG. 4 is a scene 400 depicting a second example traffic scene. In FIG. 4, motorcyclist 402 may be traveling at a rate of speed higher than vehicle 102. Non-camera sensors, e.g., non-camera sensors 108 of FIG. 1, may perform discrete ultrasonic, radar, and/or LIDAR measurements, for example, which may facilitate formation of area of interest 452. Area of interest 452 may form a bounding box that encompasses motorcyclist 402. In the instance of scene 400, area of interest 452 is formed so as to enclose the smallest possible rectangle that can be drawn and still encompass all (or substantially all) of the discrete measurements performed by non-camera sensors 108. Accordingly, computer 104 of FIG. 1 may determine that scene compression is to occur in accordance with application of a first compression rule, in which a portion of scene 400 that corresponds to area of interest 452 is to undergo zero or negligible compression. In accordance with application of a second compression rule, portions of the scene exclusive of area of interest 452 may undergo lossy compression.

In example embodiments, further reduction of vehicle network communications bandwidth may be achieved via application of a compression rule in which minimal compression may be applied to portions of a scene that include objects determined to be stationary objects, whose relative motion corresponds exclusively to egomotion of vehicle 102. Hence, in reference to FIGS. 2A, 2B, and 3, in accordance with application of a compression rule, portions of a scene that include stationary objects, e.g., trees 224, 226, and 228, as well as traffic lights 208, 210, and 212, may undergo an intermediate level of lossy compression, such as compression resulting in less than a threshold of loss in image resolution. Such relatively minimal, e.g., non-zero or non-negligible, lossy compression may ensure that sufficient resolution of a portion of the scene corresponding to an area of interest is retained so as to facilitate further image processing/image analysis by computer 104 of FIG. 1. In some instances, responsive to determining that a detected moving or stationary object is presently, or potentially, within the driving path of vehicle 102, subsequent processing of a captured image may direct or influence a driver assistance system. Such direction or influence could include adjusting a speed and/or distance setting of a driver assistance system. In this context, a driver assistance system refers to a vehicle component or set of vehicle components 110 comprising a vehicle subsystem by which computer 104 can control one or more of vehicle steering, propulsion, and/or braking. Such systems may be referred to as Advanced Driver Assistance Systems (ADAS). ADAS can include systems such as adaptive cruise control, which can control speed of a vehicle in certain situations, including by adapting the speed of vehicle 102 to one or more other vehicles; lane-centering, in which vehicle 102 steering is controlled to maintain a lateral position of a vehicle 102 in the lane of travel; and lane-changing, in which a motion vector of vehicle 102 can be controlled to move the vehicle from one lane of travel to another. These ADAS can have speed and/or distance settings or parameters.

### Example Processes

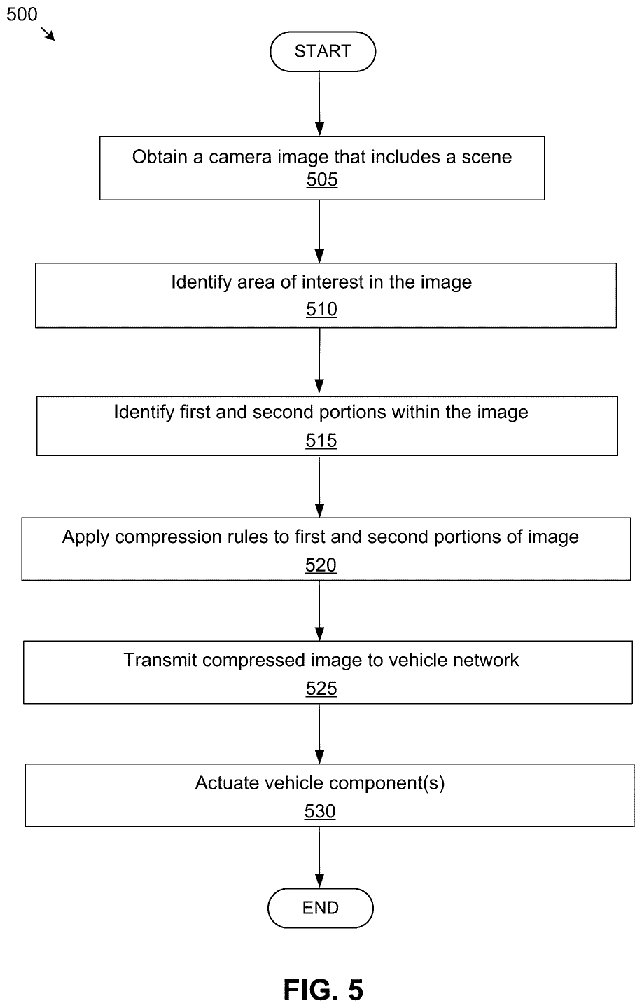

FIG. 5 is a process flow diagram of an example process 500 for rule-based digitized image compression in vehicle 102. Process 500 can be carried out according to instructions in vehicle computer 104, for example.

Process 500 can begin while the vehicle 102 is operating on a path, such as path 202 of FIG. 2A. In such an instance, non-camera sensors 108 cooperating with computer 104 can determine presence of stationary and/or moving objects that may be within a specified distance of vehicle 102 or a path of vehicle 102. For example, a specified distance may be determined according to a speed of vehicle 102, a type of roadway on which a vehicle 102 is traveling (e.g., two-lane highway, four-lane highway, interstate highway, city surface street, etc.) and/or other parameters. Other parameters may include an amount of ambient light, a time of day, etc. The specified distance may be stored in a memory of computer 104 and retrieved according to parameters such as described above. Thus, as noted above, computer 104 may determine that non-camera sensors 108, which may include radar, ultrasonic, and/or LIDAR emitters and receivers, have provided data from which stationary and/or moving objects are detected, such as moving vehicles 214, 216, and 218, as well as stationary objects, such as trees 224, 226, and 228.

At block 505, computer 104 of vehicle 102 may obtain a camera image, to include a scene. A scene may include any portion of the environment external to the vehicle, such as a scene encompassing a direction forward of vehicle 102, a direction to the right of vehicle 102, a direction to the left of vehicle 102, and so forth.

The process 500 may continue at block 510, in which a camera, e.g., camera 105, cooperating with computer 104 of vehicle 102, may identify an area of interest in a scene. An area of interest may include areas within a scene that include, or are estimated to include, stationary or moving objects in the path, or potentially in the path, of vehicle 102. An area of interest may provide a basis for forming a bounding box that encompasses a static or moving object. An area of interest can be formed so as to enclose the smallest possible rectangle that can be drawn and still encompass all (or substantially all) of the discrete measurements performed by non-camera sensors onboard a vehicle. Computer 104 of vehicle 102 may utilize a process to track an area of interest, such as area of interest 310 of FIG. 3, as vehicle 102 undergoes motion along path 202.

The process 500 may continue at block 515, which may include identifying, based on the non-camera sensor data, a first portion of the camera image that includes the area of interest. Block 515 may additionally include identifying a second portion of a camera image that excludes the area of interest, such as areas that include free space in the scene.

The process 500 may continue at block 520, in which the camera may apply a first compression rule to the first portion of the camera image, such as a portion of the camera image that includes an area of interest. Block 520 may additionally include applying a second compression rule to a second portion of the camera image, such as a portion of the camera image that includes free space.

The process may continue at block 525, which may include transmitting a compressed image to other computing entities onboard vehicle 102. In example embodiments, a compressed image may be utilized by an ADAS or other type of component that provides vehicle driving assistance. As previously discussed, transmitting compressed images to a vehicle communications network may operate to reduce loading of a vehicle communications network, thereby ensuring that sufficient communications network bandwidth is available for conveying other types of data on the communications network. Accordingly, image compression may allow a vehicle communications bus to convey additional data from non-camera sensors, vehicle status and performance monitoring data, etc. Further, image compression may bring about reductions in wireless communications bandwidth, which may be used to communicate with computing entities external to vehicle 102, such as remote server 118.

The process may continue at block 530 which may involve, responsive to receipt of a compressed image, actuating a vehicle driving assistance component, e.g., ADAS, to perform a vehicle control operation including actuation of propulsion of the vehicle, vehicle braking, and/or vehicle steering, and/or one or more other vehicle components. For example, receipt of a compressed image by computer 104 may be a basis for actuating a haptic, audio, and/or visual output, etc.

Following block 530, the process 500 ends.

### CONCLUSION

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc., described herein, it should be understood that, although the steps of such processes, etc., have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C, Visual Basic, Java Script, Perl, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless with the high communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

What is claimed is:

1. A system, comprising:
a processor coupled to a memory that stores instructions executable by the processor to:
obtain a camera image to include a scene;
identify, from non-camera sensor data, an area of interest in the scene;
identify, based on the non-camera sensor data, a first portion of the camera image that includes the area of interest and a second portion of the camera image that excludes the area of interest; and
apply a first compression rule to the first portion of the camera image and a second compression rule to the second portion of the camera image, wherein the first compression rule is less lossy than the second compression rule.

2. The system of claim 1, wherein first compression rule operates to:
decrease compression of the first portion of the camera image.

3. The system of claim 1, wherein first compression rule operates to:
decrease compression of the first portion of the camera image; and
decrease compression nearby the first portion of the camera image.

4. The system of claim 1, wherein the instructions executable by the processor are additionally to:
determine whether the first portion of the camera image includes a moving object or includes a stationary object.

5. The system of claim 1, wherein the first compression rule is to apply a first level of decreased compression responsive to a determination that the first portion of the camera image indicates presence of a moving object, and wherein the first compression rule is to apply a second level of decreased compression responsive to a determination that the first portion of the camera image indicates presence of a stationary object.

6. The system of claim 1, wherein the first compression rule is to apply zero or negligible compression responsive to a determination that the area of interest indicates presence of a moving object.

7. The system of claim 1, wherein the first compression rule is to apply zero or negligible compression responsive to determination that the area of interest includes a moving vehicle, a moving pedestrian, a moving bicyclist, a moving motorcycle, a moving natural object, or a moving animal.

8. The system of claim 1, wherein the first compression rule is to apply non-zero or non-negligible compression responsive to a determination that the area of interest includes a stationary vehicle, a stationary pedestrian, a stationary bicyclist, a stationary natural object, or a stationary animal.

9. The system of claim 1, wherein a camera to generate the camera image and sensors to generate the non-camera sensor data are mounted on a common platform having at least partially overlapping fields-of-view.

10. The system of claim 1, wherein the non-camera sensor data comprises data from at least one of a LIDAR sensor, a radar sensor, an infrared sensor, and an ultrasonic sensor.

11. The system of claim 1, wherein the second compression rule operates to:
apply lossy compression in the second portion of the camera image that includes free space.

12. A method, comprising:
obtaining a camera image that includes a scene;
identifying, from non-camera sensor data, and area of interest in the scene;
identifying, based on the non-camera sensor data, a first portion of the camera image that includes the area of interest and a second portion of the camera image that excludes the area of interest; and
applying a first compression rule to the first portion of the camera image and a second compression rule to the second portion of the camera image, wherein the first compression rule is less lossy than the second compression rule.

13. The method of claim 12 further comprising:
applying the first compression rule to include zero or negligible compression of the first portion of the camera image.

14. The method of claim 12, further comprising:
applying the first compression rule to bring about zero or negligible compression of an area nearby the first portion of the camera image.

15. The method of claim 12, further comprising:
determining whether an object included in the first portion of the camera image corresponds to a moving object or corresponds to a stationary object.

16. The method of claim 12, comprising:
applying the first compression rule to include zero or negligible compression to the first portion of the camera image based on the first portion of the camera image including a moving object; and
applying non-zero or non-negligible compression based on the first portion of the camera image including a stationary object.

17. An article comprising:
a non-transitory computer-readable media having instructions encoded thereon which, when executed by a processor coupled to at least one memory are operable to:
obtain a camera image to include a scene;
identify, from non-camera sensor data, an area of interest in the scene;
identify, based on the non-camera sensor data, a first portion of the camera image that includes the area of interest and a second portion of the camera image that excludes the area of interest; and
apply a first compression rule to the first portion of the camera image and a second compression rule to the second portion of the camera image, wherein the first compression rule is less lossy than the second compression rule.

18. The article of claim 17, wherein the encoded instructions are additionally to:
determine whether the first portion of the camera image includes a moving object or includes a stationary object.

19. The article of claim 17, wherein the encoded instructions are additionally to:
apply zero or negligible compression to the first portion of the camera image responsive to determining that the first portion of the camera image includes a moving object.

20. The article of claim 17, wherein the encoded instructions are additionally operable to:
apply non-zero or non-negligible compression to the first portion of the camera image responsive to determining that the first portion of the camera image includes a stationary object.
